(19) United States
(12) Patent Application Publication
(10) Pub. No.: US 2016/0046039 A1
(43) Pub. Date: Feb. 18, 2016

(54) Method and System for Fabrication of Elongate Concrete Articles

(71) Applicant: VERTECH HUME PTY LTD, Werribee, Victoria (AU)

(72) Inventors: Tamas Dale Hume, Werribee (AU); Christopher A. Desailly, Werribee (AU); Denis Djakovic, Werribee (AU); Graeme R. Hume, Werribee (AU); Donald H. Hume, Werribee (AU)

(21) Appl. No.: 14/783,921

(22) PCT Filed: Apr. 11, 2014
(86) PCT No.: PCT/AU2014/000404

§ 371 Date: Oct. 12, 2015

(30) Foreign Application Priority Data
Apr. 12, 2013 (AU) 2013204660

(51) Int. Cl. B28B 7/46; B28B 23/18; B28B 11/24; B28B 13/02

(52) U.S. Cl. CPC B28B 7/46; B28B 13/021; B28B 13/0275; B28B 23/18; B28B 11/245

(57) ABSTRACT

A method for fabricating an elongate concrete article including introducing a concrete mix having a relatively high water to cement ratio into a fabrication assembly, the fabrication assembly including a core assembly and an outer mould. The method then involves dewatering in a first stage the concrete mix as it is pumped into a mould cavity formed between the core assembly and the fabrication assembly to reduce the water to cement ratio and then dewatering in a second stage the concrete mix after the mould assembly has been filled to further reduce the water to cement ratio.

### PRIORITY DOCUMENTS

The present application claims priority from Australian Complete Patent Application No. 2013204660 titled “METHOD AND SYSTEM FOR THE FABRICATION OF ELONGATE CONCRETE ARTICLES” and filed on 12 Apr. 2013, The content of this application is hereby incorporated by reference in its entirely.

### INCORPORATION BY REFERENCE

The following publications are referred to in the present application and their contents are hereby incorporated by reference in their entirety:
PCT Publication No. WO 03/090988;
PCT Publication No. WO 98/13178;
PCT Publication No. WO 2004/045819; and
PCT Publication No. WO 2005/032781,

### TECHNICAL FIELD

The present invention relates to the fabrication of elongate concrete articles such as poles, piles or pipes. In a particular form, the present invention relates to process improvements for facilitating the mass production of these concrete articles.

### BACKGROUND

The present applicant has developed over the years a fabrication process for the moulding of elongate concrete articles such as poles, piles or pipes and in particular to a process of vertical moulding of these articles. PCT Publication No. WO 03/090988 entitled “Vertical Moulding of Concrete”, filed on 24 Apr. 2003 in the name of the present applicant and whose contents are incorporated by reference in their entirety herein describes in detail a method of forming concrete articles in a vertical mould assembly having a core member where the concrete is pumped into the mould from the bottom and separation of water is inhibited in order to maintain a homogenous viscosity as the concrete mix rises in the mould. This moulding process is based generally on that described in PCT Publication No, WO 98/13178 entitled “Rapid Moulding of Long Concrete Poles”, filed on 22 Sep. 1997 in the name of Flume Brothers Pty Ltd and whose contents are also incorporated by reference in their entirety herein.

In this vertical moulding process, a core liner surrounding the core member having drainage tubes that are operable to be opened or closed is utilised in a closed configuration to prevent water being removed from the wet concrete mix as the mould is filled with wet concrete. The improvements obtained by this process resulted in automation of the fabrication of these concrete articles and the development of manufacturing facilities adopting a moulding and curing carousel arrangement as described in PCT Publication No. WO 2004045819 entitled “Moulding of Concrete Articles”, filed on 17 Nov. 2003, also in the name of the present applicant, and whose contents are incorporated by reference in their entirety herein.

A further improvement to the fabrication process by the applicant is described in PCT Publication No. WO 2005/032781 entitled “Vertical Moulding of Long Concrete Articles”, filed on 6 Oct. 2004 in the name of the present applicant and whose contents are incorporated by reference in their entirety herein. This improvement involved increasing the moulding pressure after filling and an expandable inner core portion that is operable to apply this increased pressure.

While the above fabrication processes have been adequate, there are a number of disadvantages which have a direct impact on product yields, ease of manufacturing and the ability to automate this process. One important issue is that this moulding process can result in excess water being “squeezed” out of the concrete mix during the filling process which then settles on top of the concrete mix as it is progressively pumped from the bottom into the mould assembly. This is exacerbated by water that feeds into and up the drain tubes during the filling process which is also deposited on top of the concrete mix. This can result in a weakening of the concrete at the top of the mould assembly (ie at the bottom of the pole) as the cement is washed out of the concrete mix resulting in concrete consisting of mainly sand and stone in a segregated mix. When this segregated mix is compressed during the dewatering process the wall thickness of the pole at the base is often significantly reduced below allowable tolerances.

In order to address these issues with excess water, the water cement ratio has to be kept to a minimum of between 0.38-0.45. However, this water cement ratio results in a relatively high viscosity concrete mix which can then lead to cavities forming during filling which at the very least will detract from the cosmetic appearance of the pole or in a more serious form will lead to structural defects in the pole. Furthermore, the pumping of high viscosity concrete mix can result in displacement of the core member which will result in unacceptable variations in wall thickness. In addition, the increased pumping pressures involved can result in unnecessary stresses being placed on components resulting in increased maintenance requirements.

There is therefore a need for a fabrication method for forming elongate concrete articles capable of addressing or at least ameliorating one or more of the above disadvantages or to provide a useful commercial alternative.

### SUMMARY

In a first aspect, the present invention accordingly provides a method for fabricating an elongate concrete article, including:

introducing a concrete mix having a relatively high water to cement ratio into a fabrication assembly, the fabrication assembly including a core assembly and an outer mould;

dewatering in a first stage the concrete mix as it is pumped into a mould cavity formed between the core assembly and the fabrication assembly to reduce the water to cement ratio; and

dewatering in a second stage the concrete mix after the mould assembly has been filled to further reduce the water to cement ratio.

In another form, the dewatering in a first stage includes introducing a pressure drop between the concrete mix and a core portion of the core assembly to transfer water from the concrete mix to the core portion as the concrete mix is pumped into the cavity.

In another form, introducing a pressure drop includes providing a filtering means located between the core portion and the outer mould.

In another form, dewatering in a first stage includes draining from the core portion water transferred via the pressure drop from the concrete mix.

In another form, the water to cement ratio as a result of the first stage dewatering is less than 0.5.

In another form, dewatering in the second stage includes compressing the concrete mix in the filled mould cavity.

In another form, compressing the concrete mix includes radially compressing the concrete mix from the core portion outwardly.

In another form, dewatering in the second stage includes, on radially compressing the concrete mix from the core portion, transferring water from the concrete mix to the core portion.

In another form, dewatering in the second stage includes draining from the core portion, water transferred from the concrete mix to the core portion.

In another form, the water to cement ratio as a result of the second stage dewatering is less than 0.3.

In another form, the water to cement ratio of the concrete mix is in the range 0.65-0.67.

In another form, the method includes maintaining the fabrication assembly in a substantially vertical orientation throughout the first and second stage dewatering.

In another form, the method includes maintaining the concrete mix introduced into the mould assembly at a predetermined mix temperature.

In another form, the predetermined mix temperature is in the range of 25±5°.

In another form, the method includes maintaining the temperature of the fabrication assembly at a predetermined fabrication assembly temperature.

In another form, the predetermined mould assembly temperature is in the range of 20±10°.

In another form, the method further includes stripping the fabrication assembly to remove the elongate concrete article.

In another form, the method further includes steam curing the elongate concrete article.

In a second aspect, the present invention accordingly provides an elongate concrete article fabricated or part fabricated by the method in accordance with the first aspect of the present invention,

In a third aspect, the present invention accordingly provides a fabrication assembly for fabricating an elongate concrete article, including:

a core assembly and an outer mould together defining a mould cavity corresponding in configuration to the elongate concrete article to be fabricated;

a concrete mix input assembly for introducing a concrete mix having a relatively high water to cement ratio into the mould cavity;

pressure drop means surrounding the core portion to transfer water from the concrete mix to the core portion as the concrete mix is pumped into the mould cavity to reduce the water to cement ratio in a first stage dewatering process; and

concrete mix compressing means to compress the concrete mix after the mould cavity has been filled to further reduce the water to cement ratio in a second stage dewatering process.

In another form, the pressure drop means includes filtering means to substantially prevent loss of fines and cement during the filling process.

In another form, the concrete compressing means includes radial compression means to radially compressing the concrete mix from the core portion outwardly.

In another form, the radial compression means includes an inflatable bladder surrounding the core portion, the bladder inflatable to extend outwardly from the core portion.

In another form, the fabrication assembly further includes drainage means to drain water transferred through the filter means from the concrete mix.

In another form, the drainage means includes a plurality of drainage tubes extending along the length of the core portion to receive water transferred through the filtering means.

In another form, the filtering means is a woven polyester fabric.

In a fourth aspect, the present invention accordingly provides a method of incorporating a load bearing mounting arrangement at an end of an elongate concrete article including:

forming a fabrication assembly including a core assembly and an outer mould defining a mould cavity to cast the elongate concrete article;

arranging within the mould cavity an elongate reinforcement means extending along the mould cavity;

attaching a load bearing mounting arrangement at one end of the of the elongate reinforcement means, the load bearing mounting arrangement located substantially within the mould cavity; and

filling the mould cavity with a concrete mix to integrally mould the load bearing mounting arrangement into the elongate concrete article.

In another form, the mould cavity is of an annular configuration to form a hollow cylindrical pole and the load bearing mounting arrangement is a ring member forming a peripheral mounting region at an end of the pole.

In another form, the fabrication assembly is maintained in a substantially vertical configuration during filling of the mould cavity with concrete mix.

In another form, the concrete mix is pumped from the bottom of the fabrication assembly through the load bearing mounting arrangement.

In another aspect, there is provided a method for fabricating a steel reinforced non-conductive concrete article including:

forming a fabrication assembly including a core assembly and an outer mould defining a mould cavity to cast the elongate concrete article;

arranging within the mould cavity a steel reinforcing assembly, the steel reinforcing assembly including a first steel reinforcing arrangement extending along a first sub-length of the cavity and a second steel reinforcing arrangement extending along a second sub-length of the cavity, wherein the first and second steel reinforcing arrangements are spaced apart to introduce a non-conductive region between the first and second steel reinforcing arrangements; and

filling the mould cavity with a concrete mix to fabricate the concrete article.

In another form, the first and second steel reinforcing arrangements overlap and are spaced apart radially within the mould cavity to introduce the non-conductive region.

In another form, the first and second steel reinforcing arrangements are spaced apart longitudinally within the mould cavity.

In another form, the steel reinforcing assembly includes an intermediate steel reinforcing arrangement extending between to the first and second longitudinally spaced apart steel reinforcing arrangements, the intermediate steel reinforcing arrangement overlapping with one or both of the first and second longitudinally spaced apart steel reinforcing arrangements but spaced radially from the one or both first and second longitudinally spaced apart steel reinforcing arrangements to ensure that there is a non-conductive region between all of the first, second and intermediate steel reinforcing arrangements.

In another form, the reinforcing arrangements have a cage structure consisting of longitudinally extending lengths and circumferential rings spaced along the longitudinally extending lengths.

In another aspect, there is provided a steel reinforced non-conductive concrete article according to the method described above.

### BRIEF DESCRIPTION OF DRAWINGS

Illustrative embodiments of the present invention will be discussed with reference to the accompanying drawings wherein:

FIG. 1 is a flow chart diagram of a method for fabricating an elongate concrete article in accordance with a first illustrative embodiment of the present invention;

FIG. 2 is an exploded perspective view of a fabrication assembly for an elongate concrete article in accordance with an illustrative embodiment of the present invention prior to assembly;

FIG. 3 is a perspective view of the fabrication assembly illustrated in FIG. 2 in an assembled configuration prior to filling with concrete mix;

FIG. 4 is a top sectional view of the assembled fabrication assembly illustrated in FIG. 3 filled with concrete mix;

FIG. 5 is again a top sectional view of the assembled fabrication assembly illustrated in FIGS. 3 and 4 showing the expansion of the radial compression means;

FIG. 6 is an exploded perspective view of the opened fabrication assembly following first and second stage dewatering of the concrete mix depicting the elongate concrete article;

FIG. 7 is a top sectional view similar to that of FIG. 4 of the opened fabrication assembly as illustrated in FIG. 6;

FIG. 8 is a bottom sectional view of an assembled fabrication assembly similar to that illustrated in FIG. 3 but now incorporating a load bearing mounting arrangement to be integrally moulded into the elongate concrete article in accordance with a further illustrative embodiment of the present invention;

FIG. 9 is a side sectional view of the assembled fabrication assembly illustrated in FIG. 9;

FIG. 10 is a bottom sectional view of the opened fabrication assembly illustrated in FIG. 8 with the core assembly withdrawn;

FIG. 11 is a top perspective exploded view of a fabricated elongate concrete article incorporating the integrally moulded load bearing mounting arrangement and a load bearing cap to be fitted to the mounting arrangement;

FIGS. 12A and 12B are perspective and side sectional views of a steel reinforcing assembly for use in fabricating a steel reinforced non-conductive concrete article in accordance with an illustrative embodiment;

FIGS. 13A and 13B are perspective and side sectional views of a steel reinforcing assembly for use in fabricating a steel reinforced non-conductive concrete article in accordance with an illustrative embodiment; and

FIGS. 14A and 14B are perspective and side sectional views of a steel reinforcing assembly for use in fabricating a steel reinforced non-conductive concrete article in accordance with yet another illustrative embodiment.

In the following description, like reference characters designate like or corresponding parts throughout the several views of the drawings.

### DESCRIPTION OF EMBODIMENTS

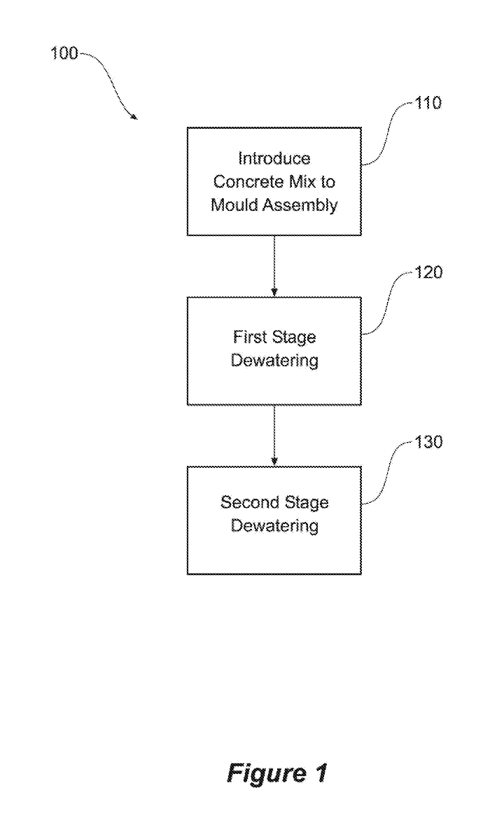

Referring now to FIG. 1, there is shown a flow chart diagram of a method 100 for fabricating an elongate concrete article according to an illustrative embodiment of the present invention. In this illustrative embodiment, the present invention is discussed in relation to a 12.5 metre hollow section 16/8 kN slack cage tapered cylindrical concrete pole having a general wall thickness of 65 mm and suitable for the distribution of power. As would be appreciated by those skilled in the art, the present invention will be equally applicable to other hollow concrete articles including, but not limited to piles, poles or pipes either of constant cross section or varying cross sectional size and profile.

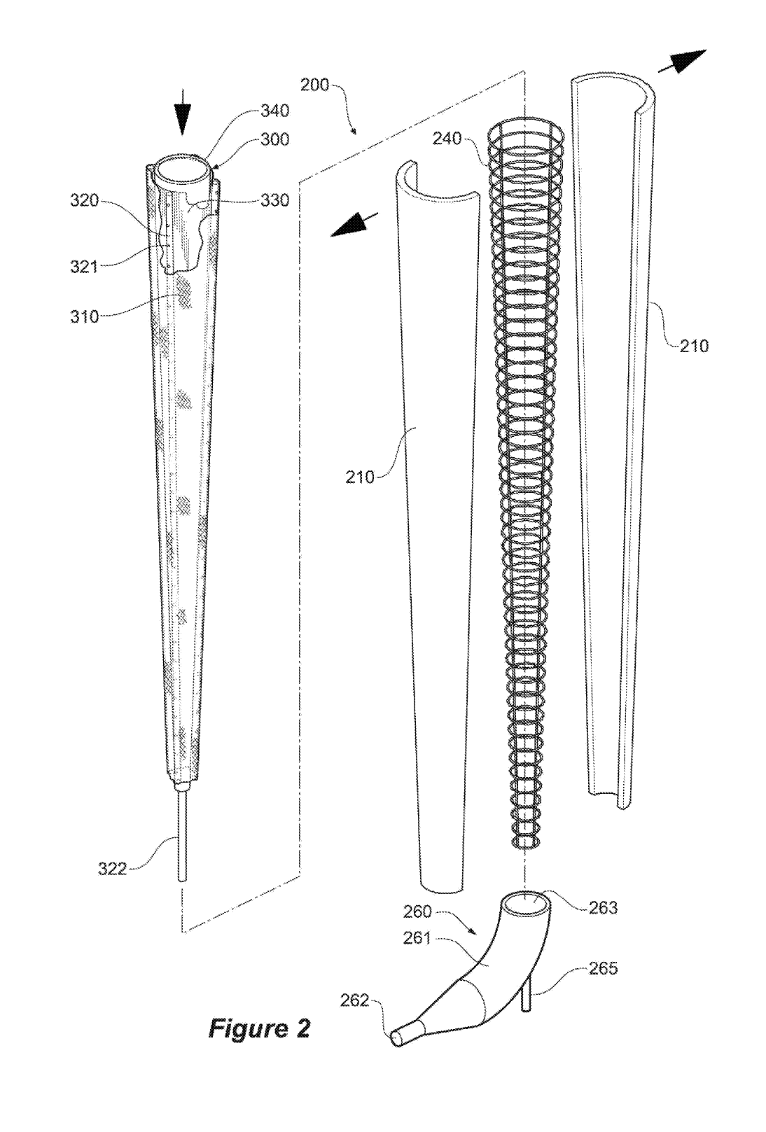

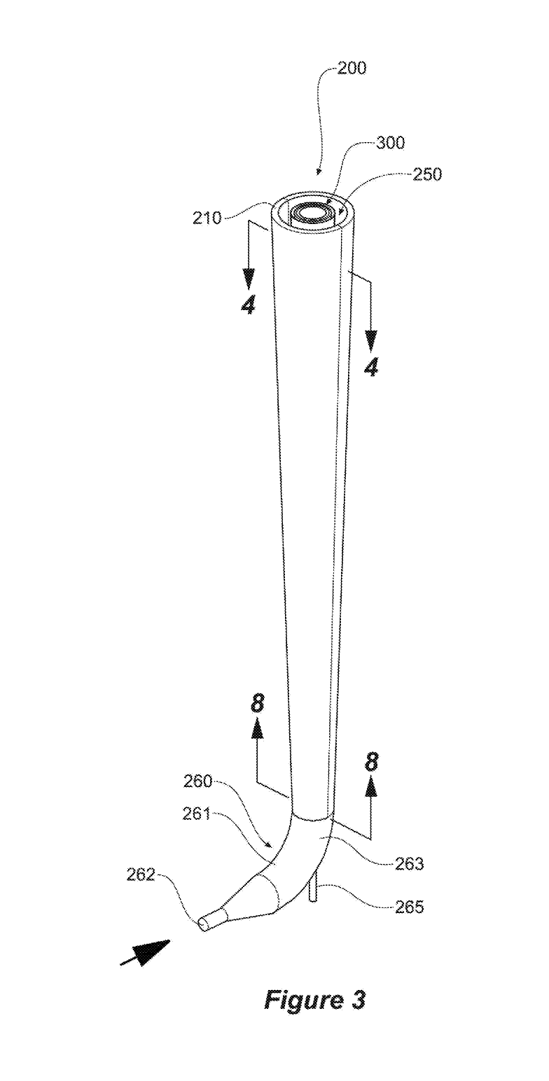

Referring to FIGS. 2 and 3, at step 110, a concrete mix having a relatively high water to cement ratio (0.66 in this illustrative embodiment) is introduced into fabrication assembly 200 consisting of a core assembly 300, two opposed tapered semi cylindrical mould portions 210 forming an outer mould and optional reinforcement cage 240 that seats within the tapered annular shaped cavity or moulding region 250 formed between the core assembly 300 and the joined outer mould portions 210. Concrete mix is introduced in cavity 250 by concrete input assembly 260 consisting of elbow portion 261 having an inlet 262 to receive the concrete mix and whose outlet 263 is joined to the bottom of joined mould portions 210. Concrete input assembly 260 further includes drain outlet 265 to allow water to drain from core assembly 200.

In other illustrative embodiments, the water to cement ratio may be in the range 0.554/57, 0.57-0.59, 0.59-0.61, 0.61-0.63, 0.63-0.65, 0.65-0.67, 0.67-0.69, 0.69-0.71, 0.71-0.73, 0.73-0.75, 0.75-0.77, 0.77-0.79 or 0.79-0.81, depending on requirements.

Core assembly 300 includes a tapered hollow core portion 340. Surrounding the core portion 340 is an inflatable bladder 330 that functions to expand or extend radially outwards from the core portion 340. Attached to the bladder 330 is a plurality of elongate drainage tubes 320 spaced around bladder 330 and extending along core portion 340 terminating in a collection tube 322, together in this embodiment forming a drainage means for draining water from the concrete mix during the fabrication process.

Each drainage tube 320 is formed from thermo plastic piping or tubing having an 8 mm outer diameter and a 1.5 mm wall thickness and further including a series of spaced apart holes 321 extending along the length of each drainage tube 320. In this illustrative embodiment, four drainage tubes 320 are employed but this number may be varied depending on the size and configuration of the pole and expected drainage rates. Surrounding the bladder 330 and drainage tube 320 arrangement is a filter membrane 310 which against extends substantially along the length of core portion 340. On assembly collection tube 322 is inserted through drain outlet 265.

In this illustrative embodiment, directed to fabricating a 12.5 metre power pole, filter membrane 310 is a woven polyester fabric having a mesh or pore size of 52 μm but this may be varied depending on the concrete mix and type of pole being fabricated. Filter membrane 310 is held in place by a suspender arrangement (not shown) that attaches to the top of core portion 340 consisting of longitudinal strapping that is used to transfer the load when the bladder 330 and filter membrane 310 are removed from the moulded product. Filter membrane 310 in this illustrative embodiment functions as both a pressure drop means to provide a pressure drop that in part controls the transfer of water across the membrane during dewatering as well as providing a filtering means to prevent loss of fines and cement during the filling process.

In other illustrative embodiments, filter membrane 310 may be fabricated from a nylon fabric but polyesters and in particular monofibre polyesters have been found to be particularly suitable. While in this illustrative embodiment, a unitary filter membrane 310 has been used to provide a pressure drop and filtering functionality, this may be achieved by a combination of different layers each providing either alone or in combination the required functionality.

In this illustrative embodiment, the concrete mix is set out in Table I and has a density of 2430 kg.m⁻³ and a water to cement ratio of 0.66.

TABLE 1

| Component | Amount | |
|---|---|---|
| 7 mm aggregate | 690 | kg |
| Sand | 1010 | Kg |
| Cement | 460 | Kg |
| Corrosion Inhibitor | 10 | L |
| Water | 215 | L |

As would be appreciated by those of ordinary skill in the art, a concrete mix having a water to cement ratio greater than approximately 0.45-0.50 for this type of application is contrary to standard practice due to the risk of segregation of the aggregate during pumping. The applicant has found that a relatively high water to cement ratio of greater than 0.5 and in this illustrative embodiment more preferably greater than 0.6 provides increased workability of the concrete mix to allow the concrete to be moulded in its final position in cavity 250 surrounding reinforcement cage 240 along the full extent of fabrication assembly 200.

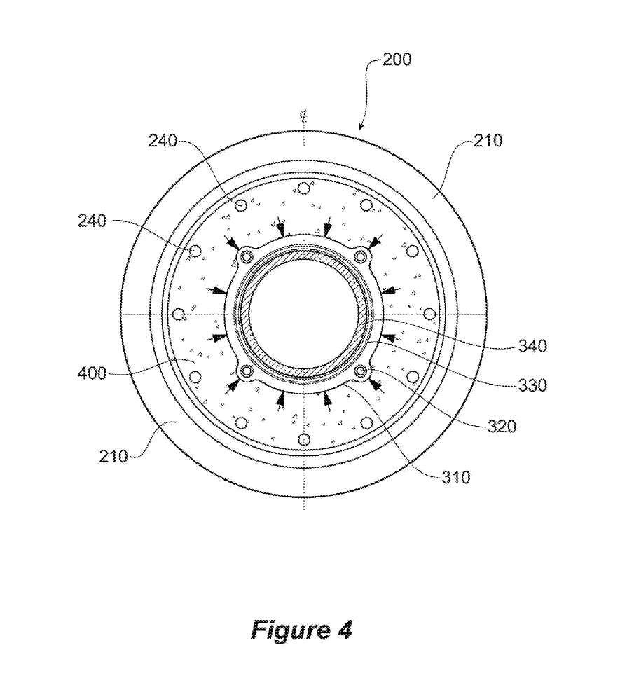

At step 120, the concrete mix is dewatered in a first stage as it is pumped into the fabrication assembly 200. Referring now also to FIG. 4, this first stage dewatering occurs as a controlled release from the combined head pressure as a result of the concrete mix being pumped generally upwardly against gravity and the pump pressure as concrete mix is introduced into cavity 250. As a result, a pressure drop is induced across the filter membrane 310 resulting in liquid transferring through the filter membrane 310 as generally indicated by the arrows in FIG. 4 to be collected by the drainage means in the form of drainage tubes 320 located between the core portion 340 and filter membrane 310.

The pressure drop across filter membrane 310 is a function of the head pressure, water to cement ratio, cement mix design, pumping pressure and related pump time. For a given configuration, the primary control variable is the pumping pressure of the concrete mix which also determines how quickly the concrete mix will rise in the mould cavity 250. The pumping pressure is controlled so as to allow liquid to escape from the concrete mix through filter membrane 310 to be drained by drain tubes 320 but not so fast that the drainage means is overwhelmed taking into account that the pressure drop will vary with the height of the fabrication assembly 200. Furthermore if too much liquid is removed from the concrete mix then the concrete mix will lost its pumpability as its viscosity increases.

In this illustrative embodiment where the height of the pole is 12.5 m, the first stage pumping is at a pumping pressure of 3-5 kPa and the dewatering process takes approximately 5 minutes with approximately 50% of the water in the concrete mix being extracted from the concrete mix while maintaining its pumpability.

Filter membrane 310 in this illustrative embodiment not only provides a filtering function that allows for the removal of a water while retaining the fines, cement, sand etc, of the concrete mix which goes to the concrete quality and surface finish but it provides a predetermined pressure drop controlling the release of water during the dewatering stages. As discussed above, in this illustrative embodiment, filter membrane 310 consists of a proprietary woven polyester fabric. As would be appreciated by those of ordinary skill in the art, it is important that the filter membrane 310 be cleaned regularly and be replaced as required in order to maintain the desired pressure drop and filtering characteristics.

While the introduction of the concrete mix into the fabrication assembly 200 is broadly akin to the process described in PCT Publication No. WO 03/090988, it would be appreciated that the first stage dewatering process represents a substantial variation from the process described in this document where a cement ratio mix of 0.45 is employed and where there is no drainage of water from the equivalent fabrication assembly.

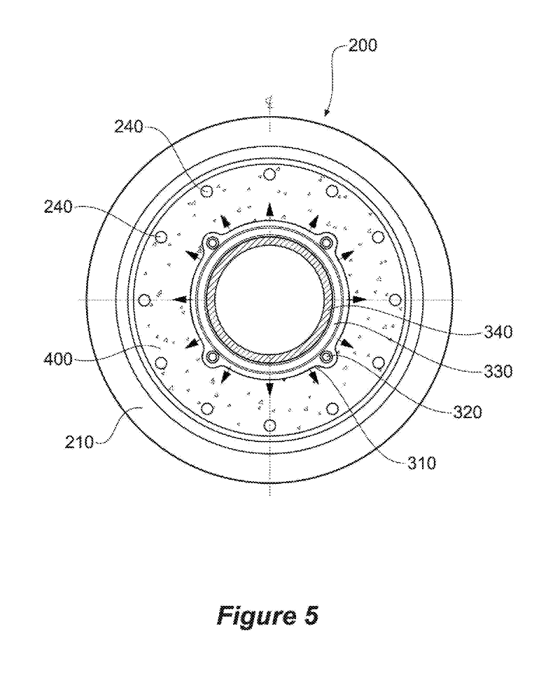

At step 130, the concrete mix is dewatered in a second stage after fabrication assembly 200 has been substantially filled with the concrete mix. Referring now also to FIG. 5, in this second stage dewatering the concrete is compressed by a radial compressing means in the form of bladder 330 located between the core portion 340 of fabrication assembly 200 and filter membrane 310 which is inflated to a pressure of 80 psi and functions to compress the concrete mix between the bladder 330 of the fabrication assembly 200 and the outer mould portions 210 of the fabrication assembly 200. In this illustrative embodiment, the second stage dewatering process is carried out for approximately 20 minutes resulting in the remaining 50% of the removable water being removed.

This compression force causes the remaining free water in the concrete mix to migrate through the mix and through filter membrane 310 where it is collected by drainage tubes 320. In this illustrative embodiment, the second stage dewatering takes approximately 20 (+10 minutes, −5 minutes) with a compression pressure of approximately 80 PSI. In this manner, the initial high water to cement ratio of 0.66 in this embodiment is reduced to approximately 0.3 following the second stage dewatering.

The applicant has found that the combination of an initial increased water to cement ratio and the first stage dewatering process maintains an enhanced state of workability of the concrete mix due to the low viscosity of the concrete mix during filling of fabrication assembly 200 resulting in improved reproducibility in the assembly filling process in terms of accurately injecting the specific density/volume of concrete required. This accurate filling of the mould without voids or cavities enables the second stage dewatering/compression stage to take place further improving the reproducibility of the pole fabrication process. The first stage filling and dewatering process also provides an important quality assurance check because if the mould is not completely full the second stage of dewatering cannot take place and as a consequence the pole cannot be removed from the mould.

It has been found somewhat surprisingly that this increased workability due to the high water to cement ratio can be achieved without the uncontrolled segregation of the mix that generally causes inconsistent manufacturing results. This is thought to be due in part to the controlled pressure drop over the filter membrane prior to the drainage of water from the concrete mix in combination with a controlled pumping rate of concrete mix.

The increased workability and consistency of filling also functions to stabilise the positioning of the core portion which results in less variability and more consistent wall thicknesses in the resultant fabricated poles. In addition, the reduced pumping pressure of 3-5 kPa as compared to the 8-10 kPa employed for standard water to cement ratios results in less wear and tear on equipment and components.

The current method addresses one of the substantial issues with the process described in PCT Publication No. WO 01090988 whereas the concrete mix fills the mould assembly water can rise up through the drainage tubes and re-enter the mould assembly above the face of the concrete being pumped into the mould. This leads to an ever increasing head of water on top of the concrete mix as it is being pumped into the mould assembly. The result is that there can be an increase in the water to cement ratio at the top of the mould (ie the bottom of the pole) so when the flexible liner on the core is expanded to commence the dewatering process and compress the concrete the water is pushed out leaving a smaller volume of concrete than is required and hence a thinner product wall and poorer quality concrete than desired.

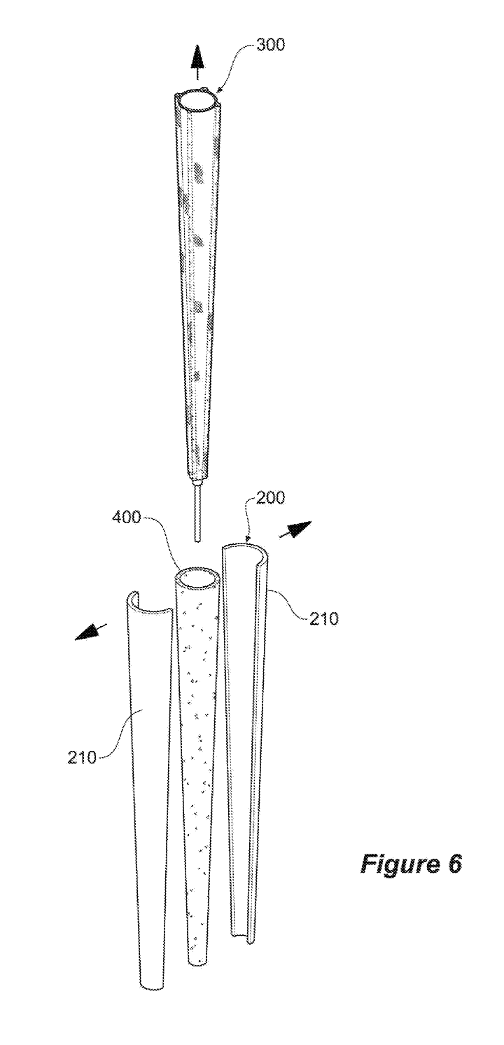

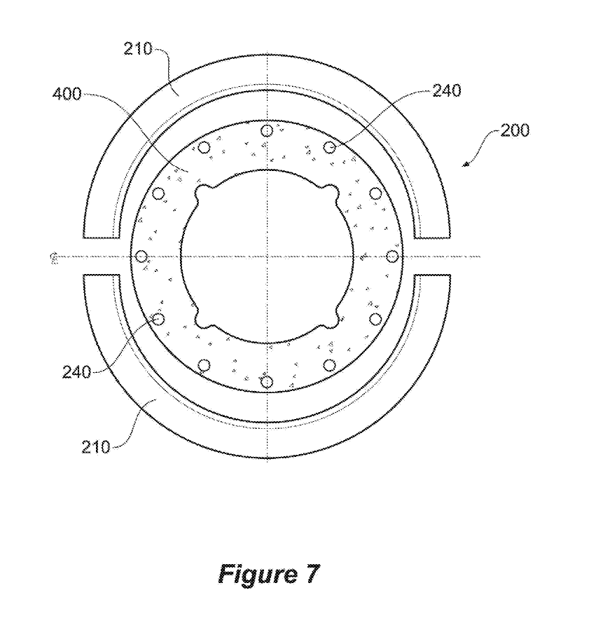

Referring now to FIGS. 6 and 7, following the filling and first stage dewatering of fabrication assembly 200 (approximately 5 minutes duration) and subsequent second stage dewatering (approximately 20 minutes duration) the concrete pole 400 is removed from the fabrication assembly 200. cured and then finally cleaned. As shown in FIG. 6, removal of concrete pole 400 from fabrication assembly 200 first involves, raising core assembly 300 from fabrication assembly 200 before the opening or stripping of mould portions 210 and attaching the pole 400 to an overhead crane for transfer to a steaming carousel for curing.

As would be appreciated by those of skill in the art, removal of the pole 400 from the fabrication assembly 200 is a stage of pole fabrication where defects in the concrete mix as pumped into the fabrication assembly 200 can result in cracking or fracturing of the concrete. The applicant has found that the two stage dewatering process where the final water to cement ratio is reduced from over 0.6 to 0.3 provides a structurally sound concrete pole that can be readily stripped from fabrication assembly 200 prior to final hydration and curing. This combination of reduced defects in the fabricated pole and the ease of removal from the fabrication assembly greatly facilitate the mass manufacturing of these articles.

In a further illustrative embodiment, the temperature of the concrete mix and fabrication assembly 200 are maintained at predetermined temperatures with the concrete mix maintained in one embodiment at a temperature in the range of 25±5° (primarily by controlling the temperature of the water) and the temperature of the mould assembly maintained at a temperature in the range of 20±10°. The applicant has found that by maintaining the concrete mix and fabrication assembly 200 in this temperature range during the filling and dewatering stages that this further facilitates removal or stripping of pole 400 from the fabrication assembly and subsequent post processing.

In addition, the pole 400 prior to final curing may undergo additional working which can only be undertaken while the concrete is in a semi-cured state. This additional working can include the following finishing processes of:
Removing any mould flashing (ie excess concrete) around the mould part line.
Removing any blanking plugs from the various fittings and ferules exposing the threads etc used to commission the pole. If at this stage any of the required fittings have been cast below the surface of the pole they must be exposed and a landing created around them providing a working face for the linesmen to work with.

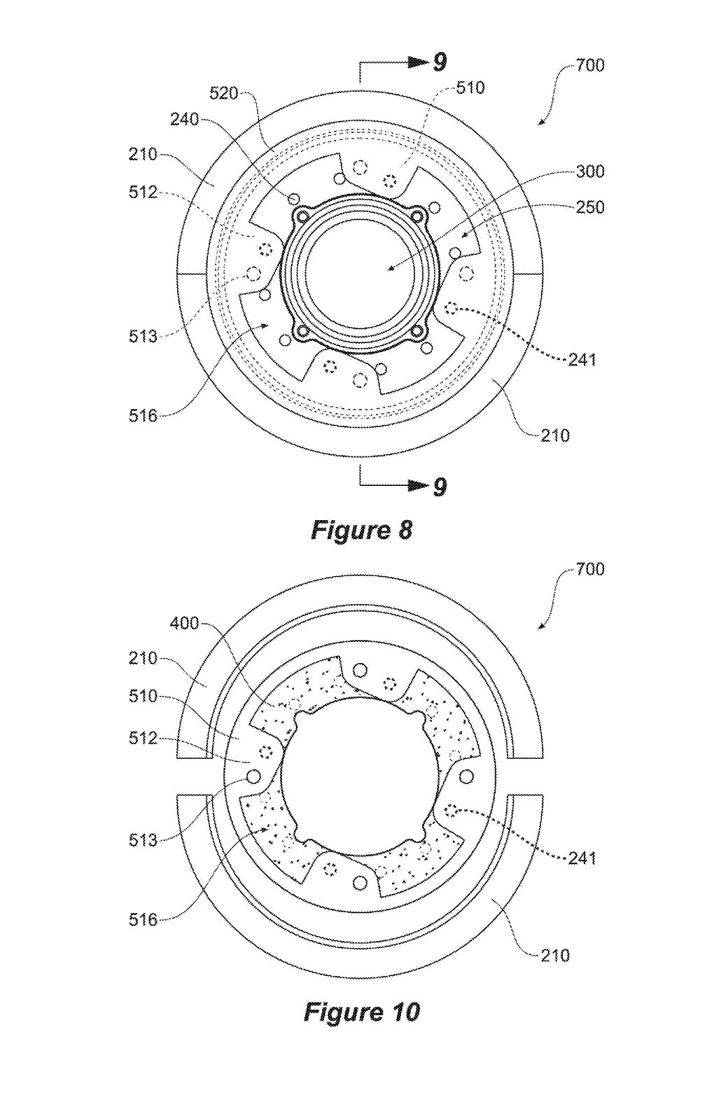

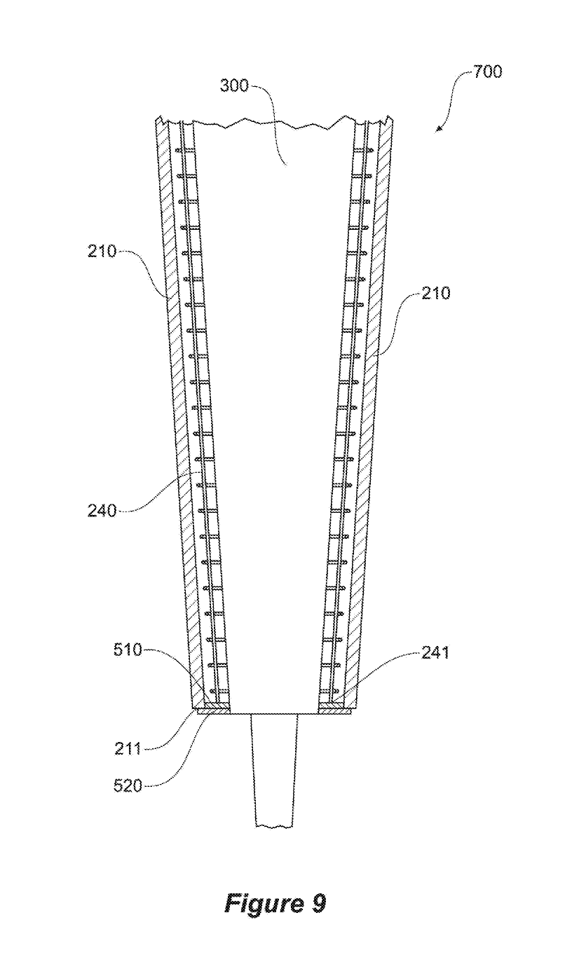

Referring now to FIG. 8, there is shown a bottom sectional view of an assembled fabrication assembly 700 according to a further illustrative embodiment that incorporates a load bearing mounting arrangement to be integrally moulded into concrete pole 400. FIG. 9 shows a side sectional view of fabrication assembly 700. In many instances, it is a requirement that the tip or top of a fabricated pole corresponding to the bottom end of fabrication assembly 700 is used as a mounting region. One non limiting example is the mounting of conductors for poles that are being used as part of an overhead electrical distribution system.

In this illustrative embodiment, load bearing mounting arrangement is a ring member 510 that is attached to the bottom end 241 of reinforcement cage 240 and on casting seated within mould portions 210 so as to be located substantially within mould cavity 250 and to extend around the edge of the bottom of the formed pole 400 as cast to form a peripheral mounting region. Ring member 510 includes four inwardly extending lobes 512 arranged at 90° with respect to each other that extend over the thickness of the formed pole 400 as best seen in FIG. 10) and which function as individual mounting regions. In this illustrative embodiment, each lobe 512 includes a mounting fixture 513 which in this example is a screw threaded aperture. In other examples, mounting fixtures 513 may include upward extending lugs or apertures to receive a clipping arrangement as known in the art.

In this example, ring member 510 is formed of mild steel having a thickness of 16 mm. As would be appreciated by those of ordinary skill in the art, the size and configuration of the ring member 510 and the mounting regions 512 may be modified according to requirements of the article to be supported. During the concrete filling process, ring member 510 further functions to maintain the concentric positioning of the reinforcement cage 240 within cavity or moulding region 250 and with respect to the mould portions 210.

In this illustrative embodiment, a further retaining flange member 520 is incorporated in fabrication assembly 700. Flange member 520 has a complementary shape to ring member 210 and in this case directly overlays and is secured to ring member 510 at the mounting regions 512 by a bolting arrangement (not shown) attached to mounting fixtures 513.

As best seen in FIG. 9, while ring member 510 is seated within mould portions 210, retaining flange member 520 has a greater diameter then the inner diameter of the bottom of the outer mould portions 210 and as such will abut against a circumferential edge region 211 of the mould portions 210. As retaining flange member 520 is attached to reinforcement cage 240 via ring member 510 it functions as a retaining means that prevents vertical movement of reinforcing cage 240 during the concrete filling process.

During filling of fabrication assembly 700, concrete is pumped from the bottom into the cavity 250 between mould portions 210 and core assembly 300 through the gaps 516 that extend between the mounting regions 512 on the ring member 510 and retaining flange member 520. As discussed previously, ring member 510 is attached to the bottom end 241 of reinforcement cage 240 (by in this case welding) which restrict any sideways movement of reinforcement cage 240 within the cavity 250. Furthermore, as ring member 510 is attached to flange member 520 which abuts the end region 211 of mould portion 210 this prevents vertical movement of reinforcement cage 240.

As would be appreciated by those of ordinary skill in the art, the above method of incorporating a load bearing mounting arrangement provides attached to the reinforcement cage provides improved load bearing capability as well as functioning to locate the reinforcement cage during the concrete filling process.

In this illustrative embodiment, the inner diameter of the edge region 211 of the outer mould portions 210 (corresponding to the tip of the pole) is of the order 25 cm and the radial width of cavity 250 is approximately 6.5 cm. The ability to pump concrete through this narrow spacing, which in this illustrative embodiment is further occluded by mounting portions 512, is yet another advantage of being able to employ a concrete mix having an initial increased water to cement ratio in accordance with the present invention that provides an enhanced degree of workability due to its low viscosity.

As shown in FIG. 10, after first and second stage dewatering the mould portions 210 may be opened or stripped as previously described and furthermore retaining flange member 520 may be removed from ring member 510.

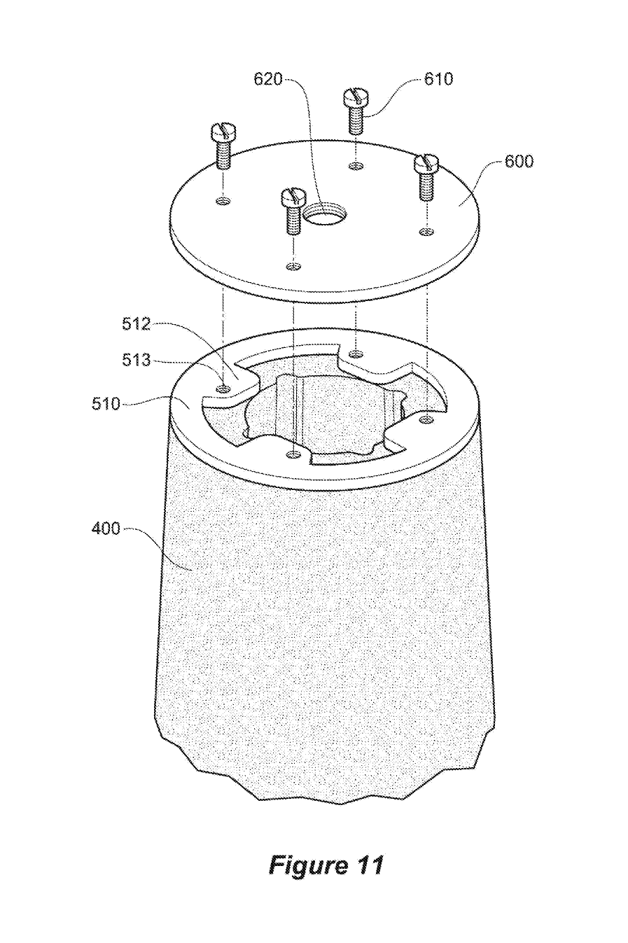

Referring now to FIG. 11, a load bearing cap member 610 incorporating its own mounting fixture 620 in the form of a screw threaded aperture may in turn be attached to ring member 510 by a bolting arrangement 610 consisting of four bolts that screw into mounting fixtures 513 in a similar way that retaining flange member 520 was initially attached to ring member 510 during the filling process.

Optionally, grout may be poured in to backfill the void between the pole tip and the cap member 610. As at this stage the concrete is still green, and hydration has only just begun prior to curing, this grout will form a homogeneous bond further enhancing the strength of the load bearing arrangement.

For final curing, the pole is steam cured in a carousel arrangement consisting of 12 separate insulated chambers to prevent temperature loss during the loading and unloading of poles. The steam lines provide steam to each of the chambers of the carousel controlling the rise and fall in humidity and temperature of each individual chamber so poles can be steam cured for a predetermined period of time. The carousel is indexed and moves in time with the pole production cycle of 28 min±3 min providing an initial curing period before removal from the carousel of 6 hours.

In the example where a load bearing cap member 610 is fitted to pole 400, the freshly grouted tip and cap member are shielded from the direct application of steam applied during the curing process. This is done most effectively by applying a rubber sleeve to the tip of pole 400 which can be later removed.

The use of a carousel arrangement results in the pole fabrication process being capable of essentially endless loop production from one mould. The rapid transfer of the pole to the steaming chamber is desirable especially in those circumstances where the concrete mix and mould assembly have been maintained at a raised temperature during the fabrication process as compared to the ambient temperature. A significant temperature drop between the temperature of the concrete and the ambient temperature may cause stress in the concrete which in turn may result in cracking of the pole.

Once the pole has been steam cured, the pole is lifted to be stored in storage racks for a further 6 hour curing or setting period at which point the pole can be finally cleaned go through a final quality inspection.

In another embodiment, the method for fabricating an elongate concrete article as has been previously described includes the ability to select the length of the final concrete article by introducing a stress discontinuity forming means at a predetermined, length along the pole. Once the concrete pole has been fabricated, the pole can be controllably broken or fractured at this stress discontinuity to provide a clean break resulting in a pole of shorter length. As an illustrative example, a 12.5 m pole may have a stress discontinuity introduced into the pole at 1.5 m from the top. This allows the top 1,5 m of the pole to be broken off leaving the remaining 11.0 m pole. In this manner, the same fabrication assembly may be advantageously used to create concrete articles of varying length.

In one embodiment, the stress discontinuity forming means is in the form of a perforation ring having a 10 mm thickness which is positioned at the required location along reinforcement cage 240. The perforation ring is configured to extend part away across the moulding region 250, typically 40%-60% of the width of moulding region 250, which on filling will cause a stress discontinuity or perforation at that location due to the change in wall thickness of the concrete article at that location once it has been fabricated.

One application of the above described embodiments is for the fabrication of concrete power poles. Typically, and as described previously, these will be conductive due to the presence of the steel reinforcement, such as reinforcing cage 240, which extends along the length of the fabricated pole. As would be appreciated, this capacity to conduct electricity is not seen necessarily as a disadvantage as often it is a requirement that the pole also provide an earth at each of the pole locations. Accordingly, electrical power distribution systems are designed to accommodate and utilise this conductive and earthing property of a standard steel reinforced concrete power pole by utilising an earthing strap when the concrete pole is installed.

There are circumstances, however, where a non-conductive pole is indicated. Examples, include where a wooden pole has been previously used and the power distribution system at that location does not necessarily require an earth. However, simply replacing a wooden pole with a steel reinforced pole which may not be properly earthed due to pre-existing ground conditions may result in a person receiving an electric shock due to the power pole being energised with respect to the ground potential due to improper grounding. Similarly, where there is a failed conductor and the power cable has come into contact with the conductive pole, this will cause the pole to become energised where previously a fault of this type would not have been a problem due to the non-conductive properties of wood. Unfortunately, while wood has some excellent properties it is not, however, resistant to fire, rot or insect and pests and for these reasons, steel reinforced concrete poles have largely replaced wooden poles. There is therefore a need for a non-conductive pole having the properties of a steel reinforced concrete pole.

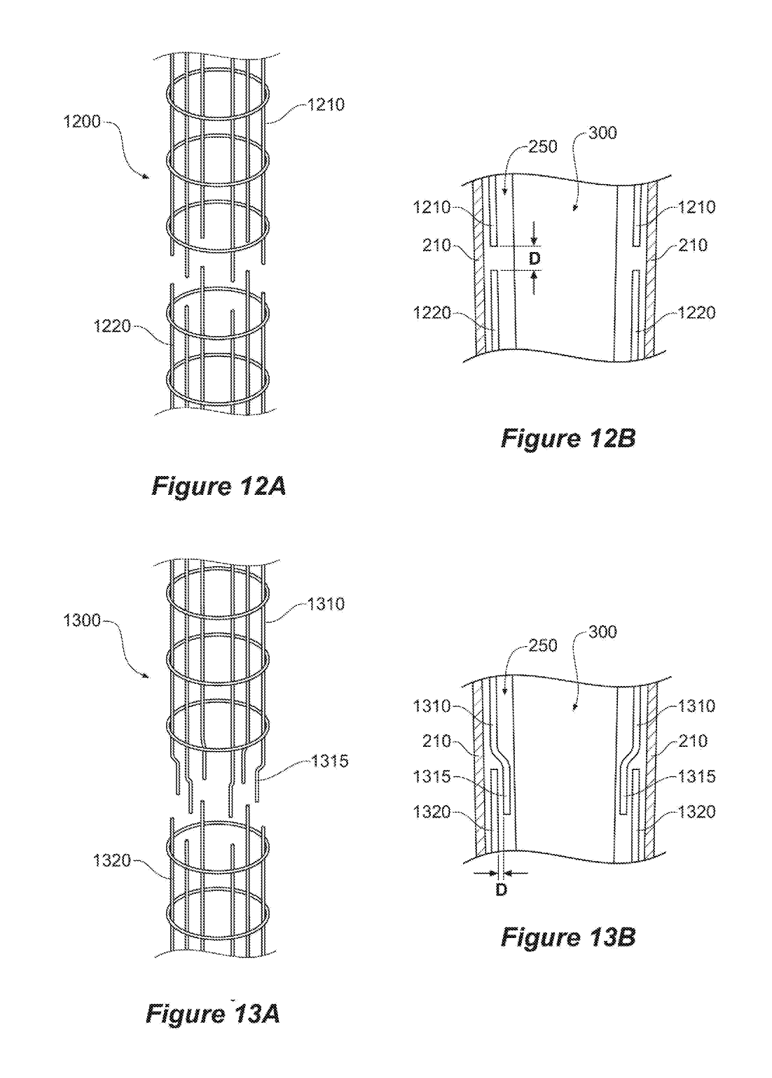

Referring now to FIGS. 12a and 12b, there are shown perspective and sectional views of a steel reinforcing assembly 1200 for use in fabricating a steel reinforced non-conductive concrete article in accordance with an illustrative embodiment. Steel reinforcing assembly includes a first steel reinforcing arrangement 1210 that extends along a first sub-length of cavity 250 and a second steel reinforcing arrangement that extends along a second sub-length of cavity 250. In this illustrative embodiment, reinforcing arrangements 1210, 1220 are in the form of reinforcement cages such as has been previously described. In other embodiments, reinforcing arrangements may consist of one or more longitudinally extending elements or helical steel wire arrangements or any combination of the above.

First and second reinforcing arrangements 1210, 1220 are spaced apart to introduce a non-conductive region between these elements characterised by as gap D which is the minimum distance between the ends of the reinforcing arrangements 1210, 1220 and hence the minimum distance between potentially conducting elements of the fabricated concrete pole. In this embodiment, the first and second reinforcing arrangements 1210, 1220 are spaced apart longitudinally within mould cavity 250 as best seen in FIG. 12b which is then subsequently filled by a concrete mix to fabricate the concrete article.

Referring now to FIGS. 13a and 13b, there are shown perspective and sectional views of a steel reinforcing assembly 1300 according to another illustrative embodiment. In this illustrative embodiment, steel reinforcing assembly 1300 includes first and second reinforcing arrangements 1310, 1320 that overlap but are spaced apart radially within the mould cavity 250 to introduce the non-conductive region characterised by the gap D. In this embodiment, the ends 1315 of first reinforcing arrangement 1310 are tapered or alternatively offset inwardly so as to extend within, and at a radial gap from second reinforcing arrangement 1320.

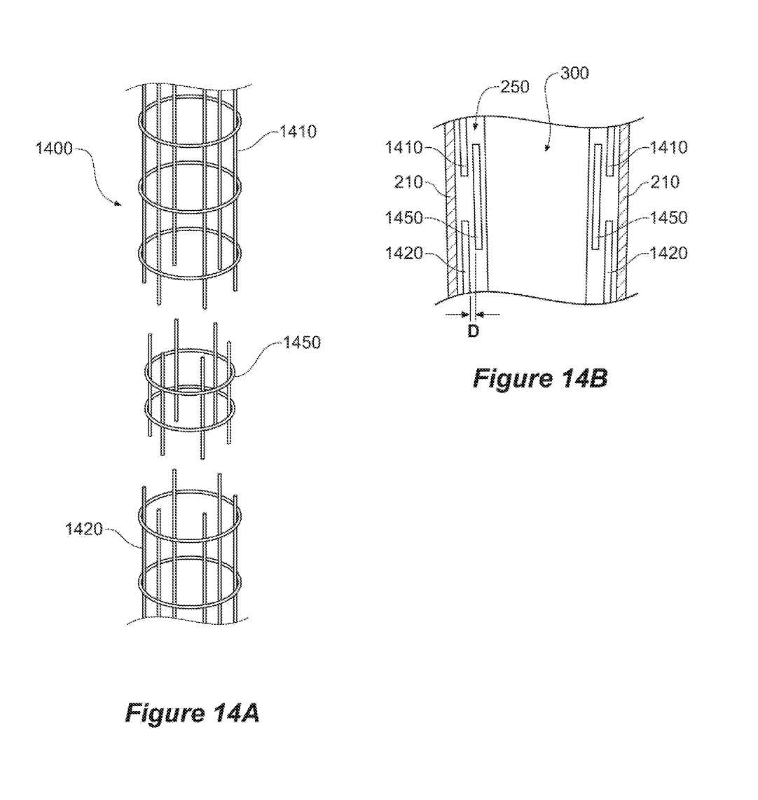

Referring now to FIGS. 14a and 14b, there shown perspective and sectional views of a steel reinforcing assembly 1400 according to yet another illustrative embodiment. Reinforcing assembly 1400 is similar to reinforcing assembly 1200 except that it includes an additional intermediate steel reinforcing arrangement 1450 extending between to the first and second longitudinally spaced apart steel reinforcing arrangements 1410, 1420 where the intermediate steel reinforcing arrangement overlaps with, in this case, both of the first and second longitudinally spaced apart steel reinforcing arrangements 1410, 1420 but spaced apart radially from the first and second longitudinally spaced apart steel reinforcing arrangements 1410, 1420 to introduce a non-conductive region characterised by the minimum distance D between all of the first, second and intermediate steel reinforcing arrangements 1410, 1420, 1450. While in this illustrative embodiment, intermediate steel reinforcing arrangement 1450 overlaps both first and second steel reinforcing arrangements 1410, 1420, in other embodiments the intermediate steel reinforcing arrangement 1450 may overlap only one of the arrangements.

It will be understood that the term non-conductive is not meant to indicate an absolute non-conductivity but that the pole is non-conductive for the purposes of its use, ie, in the context of the power distribution system that the pole will form part of, the risk of accidental electric shock is substantially mitigated.

The level of resistance that may be achieved is primarily dependent on two criteria. These include the minimum distance between any of the separate steel reinforcing arrangements, characterised in the embodiments above by the gap D, whether they be overlapping or not, and the conductivity of the concrete itself. Based on these parameters, a desired level of resistance may be designed for as required. While a desired level of resistance may be theoretically designed for, the resistance of the poles may also be empirically tested to ensure that they meet any relevant criteria. In other embodiments, insulating material such as rubber tips or the like may be placed over the ends of respective reinforcing arrangements that are within close proximity to each other.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A method for fabricating an elongate concrete article, including:
introducing a concrete mix having a relatively high water to cement ratio into a fabrication assembly, the fabrication assembly including a core assembly and an outer mould;
dewatering in a first stage the concrete mix as it is pumped into a mould cavity formed between the core assembly and the fabrication assembly to reduce the water to cement ratio; and
dewatering in a second stage the concrete mix after the mould assembly has been filled to further reduce the water to cement ratio.

2. The method as claimed in claim 1, wherein the dewatering in a first stage includes introducing a pressure drop between the concrete mix and a core portion of the core assembly to transfer water from the concrete mix to the core portion as the concrete mix is pumped into the cavity.

3. The method as claimed in claim 2, wherein introducing a pressure drop includes providing a filtering means located between the core portion and the outer mould.

4. The method as claimed in claim 2, wherein dewatering in a first stage includes draining from the core portion water transferred via the pressure drop from the concrete mix.

5. The method as claimed in claim 1, wherein the water to cement ratio as a result of the first stage dewatering is less than 0.5.

6. The method as claimed in claim 1, wherein dewatering in the second stage includes compressing the concrete mix in the in the filled mould cavity.

7. The method as claimed in claim 5, wherein compressing the concrete mix includes radially compressing the concrete mix from the core portion outwardly.

8. The method as claimed in claim 6, wherein dewatering in the second stage includes, on radially compressing the concrete mix from the core portion, transferring water from the concrete mix to the core portion.

9. The method as claimed in claim 6, wherein dewatering in the second stage includes draining from the core portion, water transferred from the concrete mix to the core portion.

10. The method as claimed in claim 1, wherein the water to cement ratio as a result of the second stage dewatering is less than 0.3.

11. The method as claimed in claim 1, wherein the water to cement ratio of the concrete mix is in the range 0.65-0.67.

12. The method as claimed in claim 1, further including maintaining the fabrication assembly in a substantially vertical orientation throughout the first and second stage dewatering.

13. The method as claimed in claim 1, further including maintaining the concrete mix introduced into the mould assembly at a predetermined mix temperature.

14. The method of claim 13, wherein the predetermined mix temperature is in the range of 25±5°.

15. The method as claimed in claim 1, further including maintaining the temperature of the fabrication assembly at a predetermined fabrication assembly temperature.

16. The method of claim 15, wherein the predetermined mould assembly temperature is in the range of 20±10°.

17. The method of claim 1, further including stripping the fabrication assembly to remove the elongate concrete article.

18. The method of claim 17, further including steam curing the elongate concrete article.

19. An elongate concrete article fabricated or part fabricated by the method of claim 1.

20. A fabrication assembly for fabricating an elongate concrete article, comprising:
a core assembly and an outer mould together defining a mould cavity corresponding in configuration to the elongate concrete article to be fabricated;
a concrete mix input assembly for introducing a concrete mix having a relatively high water to cement ratio into the mould cavity;
pressure drop means surrounding the core portion to transfer water from the concrete mix to the core portion as the concrete mix is pumped into the mould cavity to reduce the water to cement ratio in a first stage dewatering process; and
concrete mix compressing means to compress the concrete mix after the mould cavity has been filled to further reduce the water to cement ratio in a second stage dewatering process.

21. The fabrication assembly pressure of claim 20, wherein the pressure drop means includes filtering means to substantially prevent loss of fines and cement during the filling process.

22. The fabrication assembly as claimed in claim 20, wherein the concrete compressing means includes radial compression means to radially compressing the concrete mix from the core portion outwardly.

23. The fabrication assembly as claimed in claim 22, wherein the radial compression means includes an inflatable bladder surrounding the core portion, the bladder inflatable to extend outwardly from the core portion.

24. The fabrication assembly as claimed in claim 20, further including drainage means to drain water transferred through the filter means from the concrete mix.

25. The fabrication assembly as claimed in claim 24, wherein the drainage means includes a plurality of drainage tubes extending along the length of the core portion to receive water transferred through the filtering means.

26. The fabrication assembly as claimed in claim 20, wherein the filtering means is a woven polyester fabric.

27. (canceled)

28. (canceled)

29. (canceled)

30. (canceled)
